(19) United States
(12) Patent Application Publication
(10) Pub. No.: US 2024/0350975 A1
(43) Pub. Date: Oct. 24, 2024

(54) SYSTEM AND METHOD FOR ULTRAFILTRATION AND CONCENTRATION OF BIOLOGICAL COMPONENTS WITHIN A LIQUID SUSPENSION

(71) Applicants: Orgenesis Inc., Germantown, MD (US); UNIVERSITY OF CALIFORNIA DAVIS, Sacramento, CA (US)

(72) Inventors: REEM J. MIARI, SAKHNIN (IL); VERED CAPLAN, COPPET (CH); GERHARD BAUER, Sacramento, CA (US); BRIAN FURY, Sacramento, CA (US)

(73) Assignees: Orgenesis Inc., Germantown, MD (US); UNIVERSITY OF CALIFORNIA DAVIS, Sacramento, CA (US)

(21) Appl. No.: 18/686,831

(22) PCT Filed: Aug. 25, 2022
(86) PCT No.: PCT/US22/75429

§ 371 Date: Feb. 26, 2024

Related U.S. Application Data
(60) Provisional application No. 63/237,228, filed on Aug. 26, 2021.

(51) Int. Cl. B01D 61/14; B01D 63/16

(52) U.S. Cl. CPC B01D 61/145; B01D 63/16; B01D 2311/14; B01D 2321/2058; B01D 2325/02834

(57) ABSTRACT

There is provided a method of concentrating functional biological components within a liquid suspension, the method comprising: providing a system comprising an ultrafiltration/concentration unit (UCU), the UCU comprising a first chamber for receiving therein the liquid suspension. a second chamber for receiving therein the filtrate, and a filter disposed in a fluid path therebetween. the filter comprising pores sizes so as to prevent passage therethrough of the biological components: introducing the liquid suspension into the first chamber: maintaining a pressure in the first chamber being no greater than approximately 2 bar; maintaining a pressure in the second chamber being lower than that of the first chamber: and harvesting the concentrated biological components: wherein a retentate is obtained in which the concentration of the biological components therewithin is increased. relative to the liquid suspension. by a factor of at least fifty. and wherein a majority of the biological components in the retentate are functional.

### CROSS-REFERENCE TO RELATED APPLICATIONS

This application claims benefit of U.S. Provisional Patent Application No. 63/237,228, filed Aug. 26, 2022, which is incorporated by reference herein in its entirety.

### TECHNOLOGICAL FIELD

The presently disclosed subject matter relates to systems and methods for manufacturing biological components for gene therapy, and in particular to systems and method for concentrating biological components grown therefor.

### BACKGROUND

Gene therapy is a promising technology for treating and/or preventing diseases, which is based on introducing specifically selected or engineered genetic material into the patient. The genetic material, once isolated or suitably manipulated, may undergo a manufacturing process in which they are grown in a liquid suspension, resulting in a large number of individual particles comprising the genetic material. These particles may include, but are not limited to, viruses engineered to carry and/or code the genetic material.

Typically, the particles must be filtered and/or concentrated before being introduced into the patient. As gene therapy is typically customized for each patient, large-scale methods for performing these steps are often not suitable, and efficiencies which may be attainable at such scales are often not available for gene therapy. In addition, care must be taken to not damage particles undergoing filtration and/or concentration, as a relatively small number of damaged particles may represent a relatively high percentage of those manufactured at the scale performed for an individual patient. Accordingly, lower rates of damaged particles in the filtration/concentration stage allows for a shorter growth stage, as fewer particles are required to be grown to obtain the desired quantity of functional (i.e., undamaged) particles from the filtration/concentration stage. Moreover, care must be taken that the manufactured particles are protected from contamination.

### SUMMARY

According to an aspect of the presently disclosed subject matter, there is provided a method of concentrating functional biological components within a liquid suspension, the method comprising:
providing a system comprising an ultrafiltration/concentration unit (UCU), the UCU comprising a first chamber for receiving therein the liquid suspension, a second chamber for receiving therein the filtrate, and a filter disposed in a fluid path therebetween, the filter comprising pores sizes so as to prevent passage therethrough of the biological components;
introducing the liquid suspension into the first chamber;
maintaining a pressure in the first chamber being no greater than approximately 2 bar;
maintaining a pressure in the second chamber being lower than that of the first chamber; and
harvesting the concentrated biological components;
   wherein a retentate is obtained in which the concentration of the biological components therewithin is increased, relative to the liquid suspension, by a factor of at least fifty, and wherein a majority of the biological components in the retentate are functional.

At least 60% of the biological components in the retentate may be functional.

At least 80% of the biological components in the retentate may be functional.

The concentration of the biological components within the retentate may be increased, relative to the liquid suspension, by a factor of at least 75.

The concentration of the biological components within the retentate may be increased, relative to the liquid suspension, by a factor of at least 100.

The concentration of the biological components within the retentate may be increased, relative to the liquid suspension, by a factor of at least 125.

The biological components may be selected from a group including one or more viral vectors, one or more lentiviruses, one or more vaccines, one or more antibodies, one or more cells, one or more nucleic acids, one or more non-viral gene therapy vectors, and one or more biomolecules.

The biological components may comprise severe acute respiratory syndrome coronavirus 2 (hereinafter, SARS-CoV-2) viral particles.

The method may further comprise spinning the UCU in a centrifuge, thereby giving rise to a centrifugal force on the liquid suspension in the first chamber directed toward the second chamber. The centrifugal force may be between 375 g and 425 g.

The USU may be spun in the centrifuge continuously for at least one hour.

The UCU may define, at least during the concentration of biological components, a closed system.

According to some examples, the liquid suspension is not recirculated.

The pressure in the first chamber may be maintained substantially at a constant pressure.

The pressure differential between the first and second chambers may be less than about 1 bar.

The pressure differential between the first and second chambers may be maintained at a substantially constant level.

The method may further comprise vibrating the filter.

The method according to any one of the preceding claims, wherein the pressure is controlled in each of the chambers by fluidly connecting an external source of gas thereto. The gas may be nitrogen.

The system may further comprise one or more sensors to measure the pressure in each of the chambers.

The system may further comprise one or more sensors, each selected from a group including a temperature sensor, a fluid level sensor, a pH sensor, and a Hall effect sensor.

The system may be configured to monitor outputs of the sensors, and to initiate or more corrective actions in response to at least one of the outputs deviates beyond a predetermined range.

The filter may be a 40 kDa filter, 50 kDa filter, a 70 kDa filter, or a 100 kDa filter.

The filter may comprise pores of about 0.20 μm, or of about 0.45 μm.

The UCU may comprise a plurality of filters. The filters may be arranged such that those closer to the second chamber have a smaller pore size than those closer to the first chamber.

The pores in the filter may be substantially of uniform size.

The system may further comprise a control tower configured to autonomously direct at least a portion of the operations within the UCU.

The control tower may comprise a grip configured to hold and selectively tilt the UCU.

According to another aspect of the presently disclosed subject matter, there is provided a system for concentrating biological components within a liquid suspension, the system comprising:
an ultrafiltration/concentration unit (UCU), the UCU comprising a first chamber for receiving therein the liquid suspension, a second chamber for receiving therein the filtrate, and a filter disposed in a fluid path therebetween, the filter comprising pores sizes so as to prevent passage therethrough of the biological components;
the system being configured to maintain a pressure in the first chamber no greater than approximately 2 bar and to maintain a pressure in the second chamber lower than that of the first chamber;
   wherein the system is configured to produce a retentate in which the concentration of the biological components therewithin is increased, relative to the liquid suspension, by a factor of at least fifty, and wherein a majority of the biological components in the retentate are functional.

The system may be configured to concentrate the biological components such that at least 60% of the biological components in the retentate are functional.

The system may be configured to concentrate the biological components such that at least 80% of the biological components in the retentate are functional.

The system may be configured to concentrate the biological components such that the concentration of the biological components within the retentate may be increased, relative to the liquid suspension, by a factor of at least 75.

The system may be configured to concentrate the biological components such that the concentration of the biological components within the retentate may be increased, relative to the liquid suspension, by a factor of at least 100.

The system may be configured to concentrate the biological components such that the concentration of the biological components within the retentate may be increased, relative to the liquid suspension, by a factor of at least 125.

The biological components may be selected from a group including one or more viral vectors, one or more lentiviruses, one or more vaccines, one or more antibodies, one or more cells, one or more nucleic acids, one or more non-viral gene therapy vectors, and one or more biomolecules.

The biological components may comprise SARS-CoV-2 viral particles.

The system may further comprise a centrifuge configured to spin the UCU so as to give rise to a centrifugal force on the liquid suspension in the first chamber being directed toward the second chamber. The centrifugal force may be between 375 g and 425 g.

The UCU may be configured to define a closed system.

The UCU may be configured such that, at least during concentration, the liquid suspension is not recirculated.

The system may be configured to maintain the pressure in the first chamber substantially at a constant pressure.

The system may be configured to maintain a pressure differential between the first and second chambers which is substantially constant.

The system may be configured to maintain a pressure differential between the first and second chambers which is no greater than about 1 bar.

The system may be configured to vibrate the filter.

The system may be configured to be fluidly connected to an external source of gas to control the pressure in each of the chambers.

The system may further comprise one or more sensors to measure the pressure in each of the chambers.

The system may further comprise one or more sensors, each selected from a group including a temperature sensor, a fluid level sensor, a pH sensor, and a Hall effect sensor.

The system may be configured to monitor outputs of the sensors, and to initiate or more corrective actions in response to at least one of the outputs deviates beyond a predetermined range.

The filter may be a 40 kDa filter, 50 kDa filter, a 70 kDa filter, or a 100 kDa filter.

The filter may comprise pores of about 0.20 μm, or of about 0.45 μm.

The UCU may comprise a plurality of filters. The filters may be arranged such that those closer to the second chamber have a smaller pore size than those closer to the first chamber.

The pores in the filter may be substantially of uniform size.

The system may further comprise a control tower configured to autonomously direct at least a portion of the operations within the UCU.

The control tower may comprise a grip configured to hold and selectively tilt the UCU.

The system may comprise a plurality of the UCUs, and be configured to concentrate a single liquid suspension.

The system may comprise a single source of the liquid suspension in fluid connection with a suspension inlet of each of the UCUs, and a single collection system in fluid connection with a retentate outlet of each of the UCUs.

Retentate outlets of UCUs may be connected to suspension inlets of subsequent UCUs, thereby facilitating introduction of concentrated liquid suspension for further concentration in the subsequent UCUs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a perspective view of an ultrafiltration/concentration unit according to the presently disclosed subject matter;

FIG. 1B is an exploded view of the ultrafiltration/concentration unit illustrated in FIG. 1A;

FIG. 2 is a perspective view of a system including the ultrafiltration/concentration unit illustrated in FIG. 1A and a control tower; and

FIG. 3 illustrates a method of concentrating functional biological components within a liquid suspension using the ultrafiltration/concentration unit illustrated in FIG. 1A.

It will be appreciated that for the sake of clarity, elements shown in the figures may not be drawn to scale and reference numerals may be repeated in different figures to indicate corresponding or analogous elements.

### DETAILED DESCRIPTION

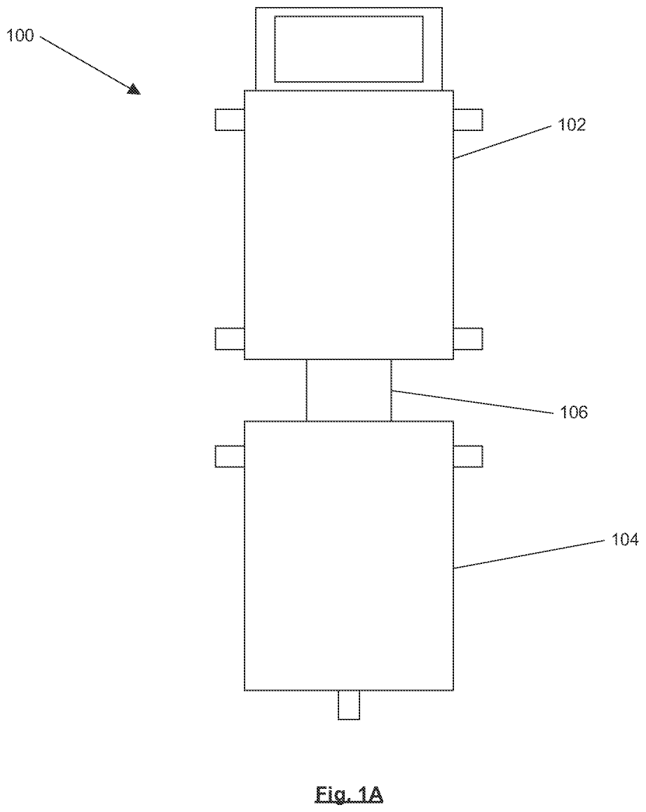

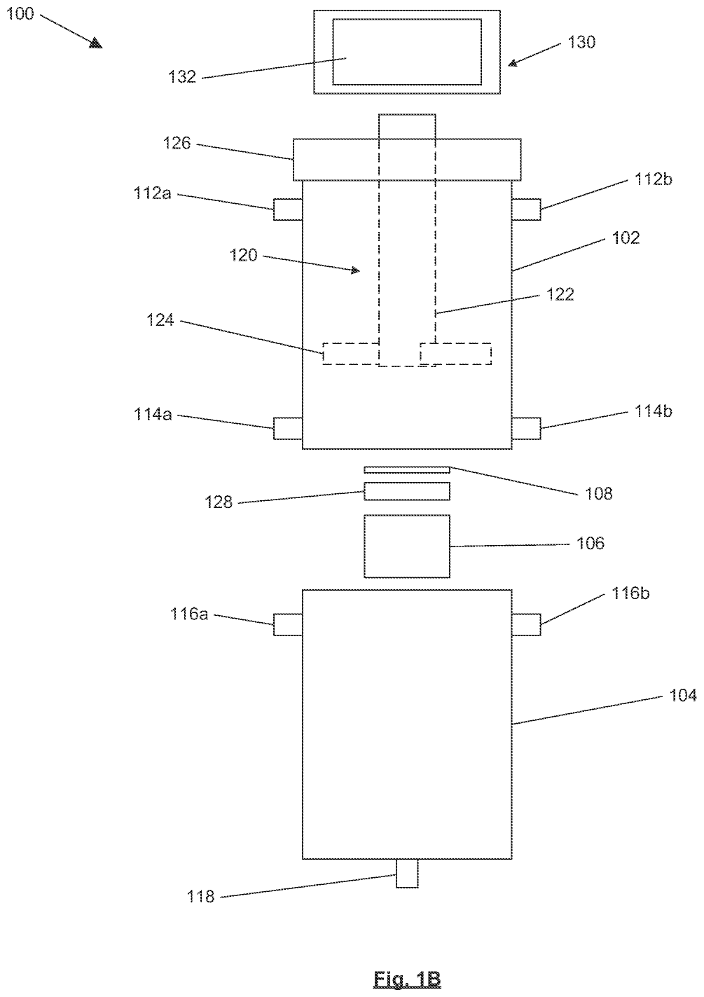

As illustrated in FIGS. 1A and 1B, there is provided an ultrafiltration/concentration unit (UCU) apparatus, which is generally indicated at 100, for facilitating concentrating functional biological components within a liquid suspension. In particular, the UCU 100 is configured to facilitate the concentration wherein a high percentage of the biological components harvested thereafter remain functional, i.e., have not sustained damage to an extent which would render them non-functioning and/or inoperable for their intended purposes. The biological components may be and/or comprise any type of DNA or RNA particles, in particular, but not limited to, viral or vector particles, proteins, exosomes, etc.

It will be appreciated that herein references to concentration, a concentration process, and other related terms are non-limiting and used for convenience only, and may also refer to a process which comprises filtration/ultra-filtration, e.g., in addition to concentration, unless otherwise clear from context. It will be further appreciated that the term “biological components” herein the specification and appended claims refers to those biological components of interest, and other biological components which may be present e.g., incidentally, in the liquid suspension and/or retentate.

According to some non-limiting examples, the biological components comprise viruses. According to other non-limiting examples, the biological components comprise viral vectors, one or more lentiviruses, one or more vaccines, one or more antibodies, one or more cells, one or more nucleic acids, one or more non-viral gene therapy vectors, and/or one or more biomolecules. According to some non-limiting examples, the biological components may comprise SARS-CoV-2 viral particles.

The UCU 100 comprises a first chamber 102 for receiving therein the (pre-filtered) liquid suspension, a second chamber 104 for receiving therein the filtrate during the concentration process, and a filter assembly 106 therebetween. The filter assembly 106 defines a fluid path between the first and second chambers 102, 104, and comprises a filter membrane 108 disposed in the fluid path. The UCU 100 may further comprise a processor (not illustrated) configured to direct operation thereof, store/process information regarding the processing, etc.

The filter membrane 108 may comprise pores substantially of uniform size. According to some examples, the pores of the filter membrane 108 are approximately 0.45 μm. According to other examples, the pores of the filter membrane are approximately 0.2 μm. It will be appreciated that these are non-limiting examples, and in practice the pores may be of any suitable size.

According to some examples, the filter membrane 108 is a 100 kDa membrane (e.g., for concentration of lentivirus); according to other examples, the filter membrane 108 is a 40 kDa membrane (e.g., for concentration of adeno-associated virus). It will be appreciated that these are non-limiting examples, and in practice the pores may be characterized by any suitable molecular weight.

The filter membrane 108 may be made of any suitable material, for example cellulose acetate.

According to some examples, the UCU 100 comprises multiple filter membranes 108, for example being stacked with one another. The filter membranes 108 may have the same pore size as one another, or have different pore sizes. According to some examples, the filter membranes 108 are stacked such that the pore size decreases from that closest the first chamber 102 to that closest the second chamber 104.

The UCU 100 may comprise a plurality of ports, each providing fluid communication, for example selective fluid communication, between the interior of the UCU and the exterior thereof. Ports may be formed integrally with other elements of the UCS 100 (e.g., chambers 102, 104, filter assembly 106), and/or detachably mounted thereto.

According to some examples, the UCU 100 may be formed with a plurality of sockets, each allowing mounting thereto of a suitable connector to the facilitate fluid communication between the interior and exterior of the UCU. Some or all of the sockets may be similarly formed, for example having the same threading, thereby allowing mounting any of the connectors to any one of the similarly formed sockets, e.g., as determined by the manufacturer and/or a user.

The first chamber 102 may comprise a first and second top-ports 112a, 112b disposed near a top end thereof, and first and second bottom-ports 114a, 114b disposed near a bottom end thereof. The second chamber 104 may comprise first and second top-ports 116a, 116b disposed near a top end thereof, and a bottom-port 118 disposed near a bottom end thereof, for example formed in a bottommost surface thereof.

The UCU 100 may further comprise, in the first chamber 102 thereof, a stirring mechanism 120, configured to selectively mix the contents of the first chamber 102. According to some examples, it may comprise a magnetic stirrer disposed within the first chamber 102 and comprising a vertical support 122 with one or more paddles 124 attached to a lower end thereof and disposed directly adjacent the filter membrane 108.

The paddles 124 may have any suitable shape, in particular being configured to facilitate moving residue from the surface of the filter membrane 108 so as to prevent accumulation of retentate thereon.

An upper end of the vertical support 122 may mate with and/or be received within a rotor unit 126 disposed above the first chamber 102.

The UCU 100 may further comprise an ultrasonic shaker 128, disposed adjacent to the filter membrane 108, i.e., such that activation of the ultrasonic shaker vibrates the filter membrane. The ultrasonic shaker 128 is configured to vibrate at an ultrasonic frequency, e.g., in the rage of about 20 kHz to about 40 kHz, in order to dislodge residue from the filter membrane 108. It will be appreciated that while herein the specification and appended claims and ultrasonic shaker is described, a shake which vibrates at any other suitable frequency may be provided without departing from the scope of the presently disclosed subject matter, mutatis mutandis.

According to some examples, the ultrasonic shaker 128 may comprise one or more piezoelectric elements and an electrical connection. In use, a variable electrical signal having a desired frequency is applied via the electrical connection, causing the piezoelectric elements to vibrate at a corresponding frequency, as per the inverse piezoelectric effect. Alternatively or in addition thereto, the ultrasonic shaker 128 may be configured to receive, e.g., via the electrical connection, a non-varying current and/or a current varying at a frequency different from a desired one, and to produce a variable electrical signal of a desired frequency and apply it to the piezoelectric elements, thereby causing them to vibrate at a corresponding frequency.

The UCU 100 further comprises one or more sensors (not illustrated) for example in communication with the controller to provide information regarding measured data thereto. According to some examples, the sensors include a pressure/vacuum sensor, a temperature sensor (internal and/or external), a media level sensor, a pH sensor, a Hall-effect sensor (e.g., to measure the rate of rotation of the stirring mechanism), and/or an accelerometer. The sensors may be single-use, i.e., configured to be easily replaced by a user after use, or permanent. According to some examples, the UCU 100 may comprise a safety valve (not illustrated) configured to release pressure above a predetermined level. The controlled may be configured to initiate one or more corrective actions based on the outputs of the sensors, e.g., in the event that one or more of the outputs deviates beyond a predetermined range.

The UCU 100 may further comprise one or more user interfaces 130, configured to receive input and/or display information to a user. The user interface 130 may comprise a data presentation screen 132 configured to display data about the process being undergone, provide instructions to a user, etc. According to some examples, the data presentation screen 132 may be a touchscreen, thereby facilitating its use as a user input device as well as a presentation device.

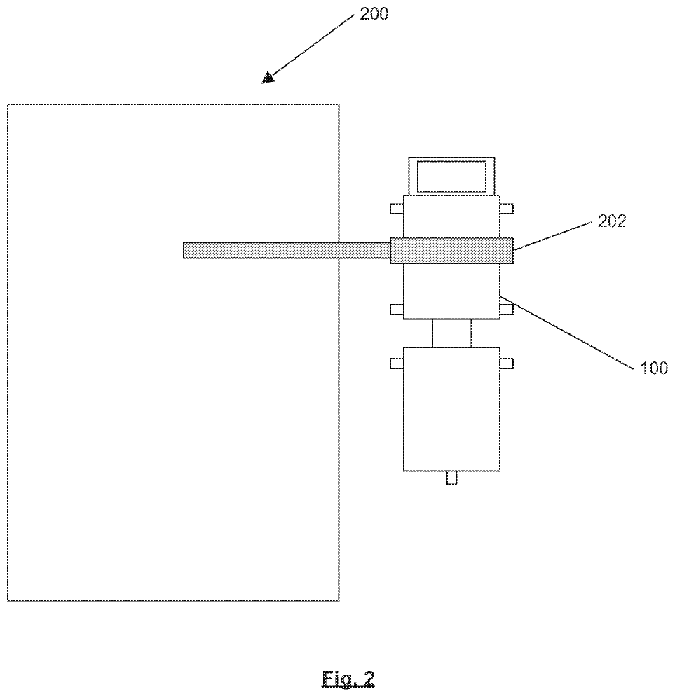

As illustrated in FIG. 2, the UCU 100 may be mounted on a control tower, which is generally indicated at 200. The control tower 200 may be configured to tilt/rotate the UCU 100, and may further direct operation thereof. In addition, it may be configured to facilitate and/or control input and/or output of fluids thereto.

According to some examples, the control tower 200 comprises a pendulum mechanism, comprising a grip 202 configured to hold the UCU 100. The pendulum mechanism may comprise an actuator (not illustrated), for example comprising a stepper motor, configured to selectively pivot the UCU 100 to one or more tilt angles during use.

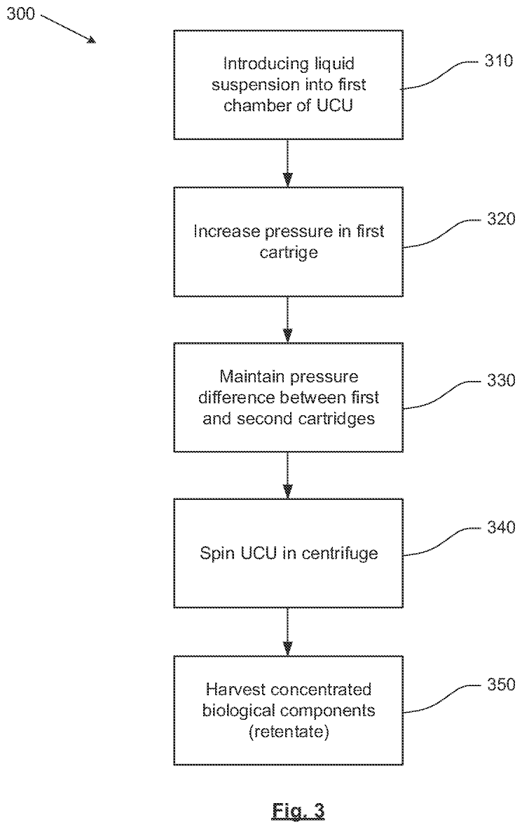

As illustrated in FIG. 3, the UCU 100 may be utilized in a method 300 of concentrating functional biological components. According to some examples, the method yields a retentate in which the concentration of the biological components is increased, relative to the concentration thereof in the liquid suspension, by a factor of at least 50. According to some examples, the method yields a retentate in which the concentration of the biological components is increased, relative to the concentration thereof in the liquid suspension, by a factor of at least 100.

According to some examples, the method results in at least 60% of the biological components in the retentate being functional, for example compared to the percentage of functional biological components in the liquid suspension. According to some examples, at least 80% of the biological components in the retentate are functional.

In step 310 of the method 300, a liquid suspension is introduced into the first chamber 102 of the UCU 100. The liquid suspension comprises functional biological components, e.g., viral vectors, one or more lentiviruses, one or more vaccines, one or more antibodies, one or more cells, one or more nucleic acids, one or more non-viral gene therapy vectors, and/or one or more biomolecules. The filter membrane 108 of the UCU 100 is selected such that its pores are sized so as to prevent passage therethrough of the biological components.

In step 320 of the method 300, the pressure in the first chamber 102 is increased to about 1 bar. According to some examples, the pressure in the first chamber 102 for the duration of the concentration is in the range between about 0 to 2 bar. The pressure may be maintained at a constant level, e.g., by the introduction of a gas, e.g., N₂.

In step 330 of the method 300, the pressure in the second chamber 104 is maintained at a pressure lower than that of the first chamber 102. The pressure of the second chamber 104 may be selected such that the pressure differential between the first and second chambers 102, 104 is within a predetermined range, e.g., about [ . . . ].

In step 340 of the method 300, the UCU 100 is introduced into a centrifuge. The centrifuge is operated to induce a centrifugal force directed from the first chamber 102 to the second chamber 104. The centrifugal force does not exceed those which the biological components can withstand, thereby maintaining their functionality. According to some examples, the maximum centrifugal force is about 400 g, for example between about 375 g and 425 g.

The centrifuge may be operated for any suitable amount of time. According to some examples, it is operated continuously for at least one hour.

In step 350 of the method 300, the retentate is harvested from the first chamber 102. This may be accomplished, e.g., by connecting a collection bag (not illustrated) to one of the bottom-ports 114 of the first chamber 102 and tilting the UCU 100 while pressure is maintained.

It will be recognized that examples, embodiments, modifications, options, etc., described herein are to be construed as inclusive and non-limiting, i.e., two or more examples, etc., described separately herein are not to be construed as being mutually exclusive of one another or in any other way limiting, unless such is explicitly stated and/or is otherwise clear. Those skilled in the art to which this invention pertains will readily appreciate that numerous changes, variations, and modifications can be made without departing from the scope of the presently disclosed subject matter, mutatis mutandis.

1. A method of concentrating functional biological components within a liquid suspension, the method comprising:
providing a system comprising an ultrafiltration/concentration unit (UCU), said UCU comprising a first chamber for receiving therein the liquid suspension, a second chamber for receiving therein the filtrate, and a filter disposed in a fluid path therebetween, said filter comprising pores sizes so as to prevent passage therethrough of said biological components;
introducing the liquid suspension into the first chamber;
maintaining a pressure in the first chamber being no greater than approximately 2 bar;
maintaining a pressure in the second chamber being lower than that of the first chamber; and
harvesting the concentrated biological components;
wherein a retentate is obtained in which the concentration of the biological components therewithin is increased, relative to the liquid suspension, by a factor of at least fifty, and wherein a majority of the biological components in the retentate are functional.

2. The method according to claim 1, wherein at least 60% of the biological components in the retentate are functional.

3. The method according to claim 1, wherein at least 80% of the biological components in the retentate are functional.

4. The method according to any one of the preceding claims, wherein the concentration of the biological components within the retentate is increased, relative to the liquid suspension, by a factor of at least 75.

5. The method according to any one of the preceding claims, wherein the concentration of the biological components within the retentate is increased, relative to the liquid suspension, by a factor of at least 100.

6. The method according to any one of the preceding claims, wherein the concentration of the biological components within the retentate is increased, relative to the liquid suspension, by a factor of at least 125.

7. The method according to any one of the preceding claims, wherein the biological components are selected from a group including one or more viral vectors, one or more lentiviruses, one or more vaccines, one or more antibodies, one or more cells, one or more nucleic acids, one or more non-viral gene therapy vectors, and one or more biomolecules.

8. The method according to any one of the preceding claims, wherein the biological components comprise SARS-CoV-2 viral particles.

9. The method according to any one of the preceding claims, further comprising spinning the UCU in a centrifuge, thereby giving rise to a centrifugal force on the liquid suspension in the first chamber directed toward the second chamber.

10. The method according to claim 9, wherein the centrifugal force is between 375 g and 425 g.

11. The method according to any one of claims 9 and 10, wherein the USU is spun in the centrifuge continuously for at least one hour.

12. The method according to any one of the preceding claims, wherein the UCU defines, at least during the concentration of biological components, a closed system.

13. The method according to any one of the preceding claims, wherein the liquid suspension is not recirculated.

14. The method according to any one of the preceding claims, wherein the pressure in the first chamber is maintained substantially at a constant pressure.

15. The method according to any one of the preceding claims, wherein the pressure differential between the first and second chambers is maintained at a substantially constant level.

16. The method according to any one of the preceding claims, wherein the pressure differential between the first and second chambers is no greater than about 1 bar.

17. The method according to any one of the preceding claims, further comprising vibrating the filter.

18. The method according to any one of the preceding claims, wherein the pressure is controlled in each of the chambers by fluidly connecting an external source of gas thereto.

19. The method according to claim 18, wherein the gas is nitrogen.

20. The method according to any one of the preceding claims, wherein the system further comprises one or more sensors to measure the pressure in each of the chambers.

21. The method according to any one of the preceding claims, wherein the system further comprises one or more sensors, each selected from a group including a temperature sensor, a fluid level sensor, a pH sensor, and a Hall effect sensor.

22. The method according to claim 21, wherein the system is configured to monitor outputs of said sensors, and to initiate or more corrective actions in response to at least one of said outputs deviates beyond a predetermined range.

23. The method according to any one of the preceding claims, wherein the filter is a 40 kDa filter.

24. The method according to any one of the preceding claims, wherein the filter is a 50 kDa filter.

25. The method according to any one of claims 1 through 22, wherein the filter is a 70 kDa filter.

26. The method according to any one of claims 1 through 22, wherein the filter is a 100 kDa filter.

27. The method according to any one of claims 1 through 22, wherein the filter comprises pores of about 0.20 μm.

28. The method according to any one of claims 1 through 22, wherein the filter comprises pores of about 0.45 μm.

29. The method according to any one of the preceding claims, wherein the UCU comprises a plurality of filters.

30. The method according to claim 29, wherein the filters are arranged such that those closer to the second chamber have a smaller pore size than those closer to the first chamber.

31. The method according to any one of the preceding claims, wherein the pores in the filter are substantially of uniform size.

32. The method according to any one of the preceding claims, wherein the system further comprises a control tower configured to autonomously direct at least a portion of the operations within the UCU.

33. The method according to claim 29, wherein said control tower comprises a grip configured to hold and selectively tilt the UCU.

34. A system for concentrating biological components within a liquid suspension, the system comprising:
an ultrafiltration/concentration unit (UCU), said UCU comprising a first chamber for receiving therein the liquid suspension, a second chamber for receiving therein the filtrate, and a filter disposed in a fluid path therebetween, said filter comprising pores sizes so as to prevent passage therethrough of said biological components;
the system being configured to maintain a pressure in the first chamber no greater than approximately 2 bar and to maintain a pressure in the second chamber lower than that of the first chamber;
wherein the system is configured to produce a retentate in which the concentration of the biological components therewithin is increased, relative to the liquid suspension, by a factor of at least fifty, and wherein a majority of the biological components in the retentate are functional.

35. The system according to claim 34, wherein at least 60% of the biological components in the retentate are functional.

36. The system according to claim 34, wherein at least 80% of the biological components in the retentate are functional.

37. The system according to any one of claims 34 through 36, wherein the concentration of the biological components within the retentate is increased, relative to the liquid suspension, by a factor of at least 75.

38. The system according to any one of claims 34 through 36, wherein the concentration of the biological components within the retentate is increased, relative to the liquid suspension, by a factor of at least 100.

39. The system according to any one of claims 34 through 36, wherein the concentration of the biological components within the retentate is increased, relative to the liquid suspension, by a factor of at least 125.

40. The system according to any one of claims 34 through 39, wherein the biological components are selected from a group including one or more viral vectors, one or more lentiviruses, one or more vaccines, one or more antibodies, one or more cells, one or more nucleic acids, one or more non-viral gene therapy vectors, and one or more biomolecules.

41. The system according to any one of claims 34 through 40, wherein the biological components comprise SARS-CoV-2 viral particles.

42. The system according to any one of claims 34 through 41, further comprising a centrifuge configured to spin the UCU so as to give rise to a centrifugal force on the liquid suspension in the first chamber being directed toward the second chamber.

43. The system according to claim 42, wherein the centrifugal force is between 375 g and 425 g.

44. The system according to any one of claims 34 through 43, wherein the UCU is configured to define a closed system.

45. The system according to any one of claims 34 through 44, wherein the liquid suspension is not recirculated.

46. The system according to any one of claims 34 through 45, configured to maintain the pressure in the first chamber substantially at a constant pressure.

47. The system according to any one of claims 34 through 46, configured to maintain a pressure differential between the first and second chambers which is substantially constant.

48. The system according to any one of claims 34 through 47, configured to maintain a pressure differential between the first and second chambers which is no greater than about 1 bar.

49. The system according to any one of claims 34 through 48, being configured to vibrate the filter.

50. The system according to any one of claims 34 through 49, configured to be fluidly connected to an external source of gas to control the pressure in each of the chambers.

51. The system according to any one of claims 34 through 50, further comprising one or more sensors to measure the pressure in each of the chambers.

52. The system according to any one of claims 34 through 51, further comprising one or more sensors, each selected from a group including a temperature sensor, a fluid level sensor, a pH sensor, and a Hall effect sensor.

53. The system according to claim 52, being configured to monitor outputs of said sensors, and to initiate or more corrective actions in response to at least one of said outputs deviates beyond a predetermined range.

54. The system according to any one of claims 34 through 53, wherein the filter is a 40 kDa filter.

55. The system according to any one of claims 34 through 53, wherein the filter is a 50 kDa filter.

56. The system according to any one of claims 34 through 53, wherein the filter is a 70 kDa filter.

57. The system according to any one of claims 34 through 53, wherein the filter is a 100 kDa filter.

58. The system according to any one of claims 34 through 53, wherein the filter comprises pores of about 0.20 μm.

59. The system according to any one of claims 34 through 53, wherein the filter comprises pores of about 0.45 μm.

60. The system according to any one of the preceding claims, said UCU comprising a plurality of filters.

61. The system according to claim 60, wherein the filters are arranged such that those closer to the second chamber have a smaller pore size than those closer to the first chamber.

62. The system according to any one of claims 34 through 61, wherein the pores in the filter are substantially of uniform size.

63. The system according to any one of claims 34 through 62, further comprising a control tower configured to autonomously direct at least a portion of the operations within the UCU.

64. The system according to claim 63, wherein said control tower comprises a grip configured to hold and selectively tilt the UCU.

65. The system according to any one of claims 34 through 64, comprising a plurality of said UCUs, and being configured to concentrate a single liquid suspension.

66. The system according to claim 65, comprising a single source of the liquid suspension in fluid connection with a suspension inlet of each of the UCUs, and a single collection system in fluid connection with a retentate outlet of each of the UCUs.

67. The system according to claim 65, wherein retentate outlets of UCUs are connected to suspension inlets of subsequent UCUs, thereby facilitating introduction of concentrated liquid suspension for further concentration in the subsequent UCUs.
